(19) United States
(12) Patent Application Publication
(10) Pub. No.: US 2024/0354779 A1
(43) Pub. Date: Oct. 24, 2024

(54) REAL FOOD HONESTY DISPLAY SYSTEM

(71) Applicant: SUNSHINE ENERGY TECHNOLOGY CO., LTD., Nantou City (TW)

(72) Inventor: CHIN-CHAN HSIEH, Nantou City (TW)

(21) Appl. No.: 18/761,636

(22) Filed: Jul. 2, 2024

Related U.S. Application Data
(63) Continuation-in-part of application No. 17/230,079, filed on Apr. 14, 2021.

(51) Int. Cl. G06Q 30/018; A01K 29/00; G06F 7/58; G06K 7/14; H04W 4/02

(52) U.S. Cl. CPC G06Q 30/018; A01K 29/005; G06F 7/588; G06K 7/1413; H04W 4/025

(57) ABSTRACT

A real food honesty display system including at least one on-site recording device, a central electronic device, at least one remote electronic device, and a network. The on-site recording device is disposed in at least one ecological environment for capturing a dynamic videos of animals, generating a geographic information showing a position coordinate, and combining the dynamic video with the geographic information to form an information set. The central electronic device is for receiving the information set and transmitting the information set to the remote electronic device. A first and a second random numbers are generated by a random number generator and a second processor of the central electronic device corresponds the first random number to the information set and coverts the second random number to a code corresponding to the information set. The remote electronic device reads the code to display the information set corresponding to the code.

### BACKGROUND OF THE INVENTION

The present invention relates to a system of recording farmer's production and sales history, and more particularly to a real food honesty display system which shoots videos of production process to provide consumers with more complete food security and safety.

### PRIOR ART

The Internet of Things (IoT) is an information carrier (such as the Internet and traditional telecommunications networks). The security issue of resource data sharing and transmission between the Internet of Things, i.e., the data protection mechanism, is a very important issue of the Internet of Things. Therefore, for virtual digital currency, the block chain technology based on peer-to-peer networks has been gradually introduced into the field of Internet of Things in recent years.

The more common food-related management system includes ISO 22000 food safety management system, FSSC 22000 food safety system certification, SQF food safety quality standards, BRC British food safety standards, TQF Taiwan fine food . . . etc. Food safety issues have received more and more widespread attention. At present practitioners in the food supply chain provide better control and stricter check in response to quality requirements of end customers.

However, “better control” and “stricter check” are not equal to complete transparency in certification, breeding, and food growth “. Thus there is room for improvement and there is a need to provide a novel system which meets the requirements mentioned above.

### SUMMARY OF THE INVENTION

Therefore, it is a primary object of the present invention to provide a real food honesty display system which combines videos or images with a geographic information to make consumers learn where food they buy is planted and produced. A food safety system from farm to table is certified by videos so that product safety for the consumers is ensured and the consumers also learn diligence of farmers or food manufacturers.

It is another object of the present invention to provide a real food honesty display system which provides a food safety solution that combines nature certification, friendly farming, fresh food purchases, and network records.

It is a further object of the present invention to provide a real food honesty display system which is capable of providing animal certification, because the food is planted or produced by friendly planting, and happy and friendly breeding of animals.

It is a further object of the present invention to provide a real food honesty display system by which a farmer voluntarily creates an environment that conforms to the diversity of organisms, and images of these organisms are captured every day to confirm safety of the planting site.

In order to achieve the above objects, a real food honesty display system according to the present invention includes at least one on-site recording device, a central electronic device, at least one remote electronic device, and a network used for connecting the central electronic device with both the on-site recording device and the remote electronic device in a wireless manner.

The on-site recording device is disposed in an ecological environment where food is planted or produced. The on-site recording device consists of an image-sound capture device, a positioning device, a first transmitter and receiver, and a first processor. The image-sound capture device is used to capture dynamic videos of at least one animal. The positioning device is for generating a geographic information showing a position coordinate of the image-sound capture device. The first transmitter and receiver is used for transmitting a plurality of information sets to the central electronic device while the information set is formed by combination of the dynamic video with the geographic information. The first processor is coupled to the image-sound capture device, the positioning device, and the first transmitter and receiver. The first processor operates to activate the image-sound capture device, make the positioning device generate the geographic information, and combine the dynamic video with the geographic information to form the information set.

The central electronic device is composed of a second transmitter and receiver, a random number generator, a storage unit, and a second processor. The second transmitter and receiver is used to receive the information set from the on-site recording device and transmit the information set corresponding to the code to the remote electronic device while the remote electronic device gets access to the code. The random number generator generates a set of a first random number and a second random number while the second transmitter and receiver receiving the information set. The storage unit is used for storage of the set of the first random number and the second random number, the information set corresponding to the first random number, and the code corresponding to the second random number. The second processor is coupled to the second transmitter and receiver, the random number generator, and the data storage unit. The second processor corresponds the first random number to the information set and converts the second random number to a code to be output. When the remote electronic device gets access to the code, the second processor finds out the second random number corresponding to the code, retrieves the set of the first random number and the second random number containing the second random number corresponding to the code, and finally gets the corresponding information set according to the first random number in the set of the first random number and the second random number containing the second random number corresponding to the code. Then the information set is output to the remote electronic device by the second processor.

The remote electronic device is used together with the code attached to food products or food packaging in at least one consumer scene. The remote electronic device is formed by a display device, a reader, a third transmitter and receiver, and a third processor. The reader is for reading the code and the third transmitter and receiver is to connect with the central electronic device for receiving the information set. The third processor is coupled to the display device, the reader, and the third transmitter and receiver. After the reader reading the code, the third processor gets the information set corresponding to the code for showing the information set on the display device.

### BRIEF DESCRIPTION OF THE FIGURES

FIG. 1 is a schematic drawing showing system structure of an embodiment of a real food honesty display system according to the present invention;

FIG. 2 is a block diagram showing structure of an on-site recording device of an embodiment according to the present invention;

FIG. 3 is a block diagram showing structure of a central electronic device of an embodiment according to the present invention;

FIG. 4 is a block diagram showing structure of a remote electronic device of an embodiment according to the present invention.

### DETAILED DESCRIPTION OF CERTAIN EMBODIMENTS

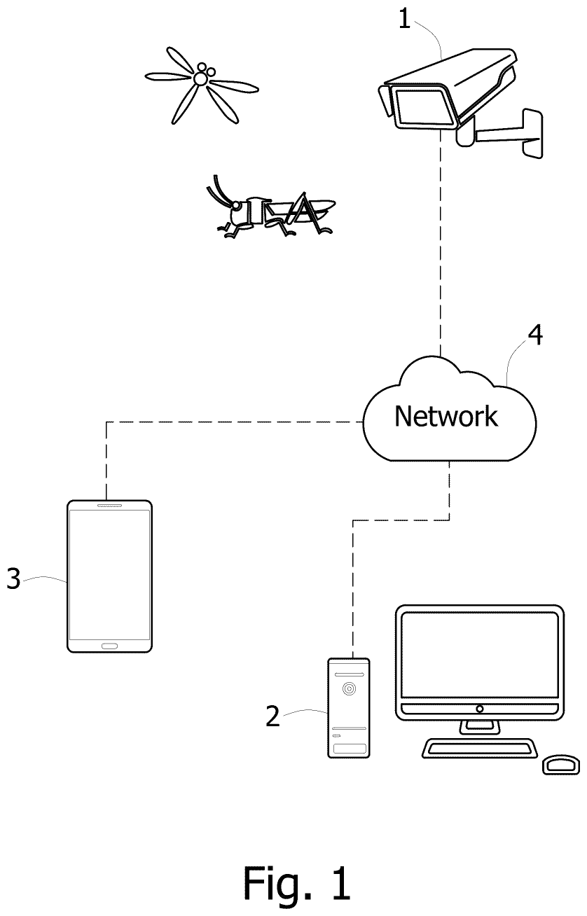

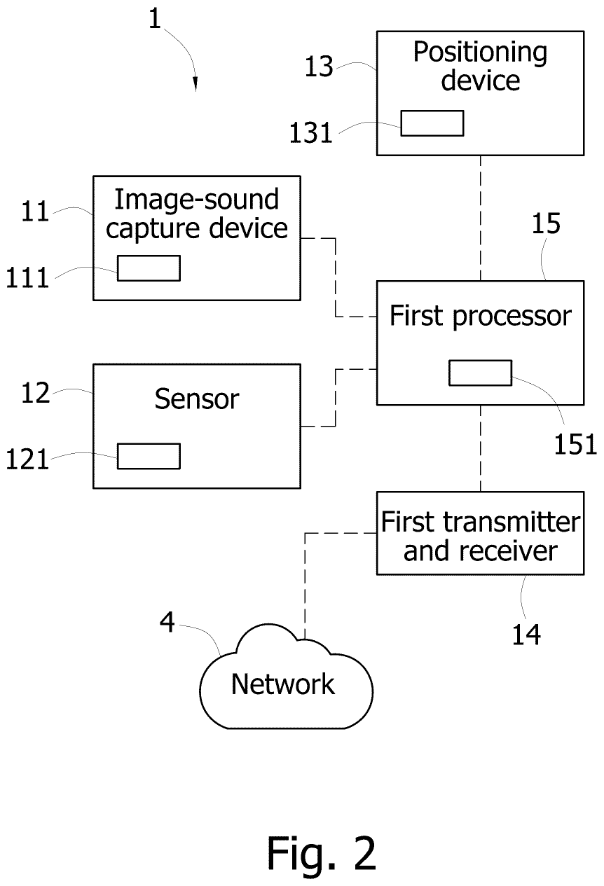

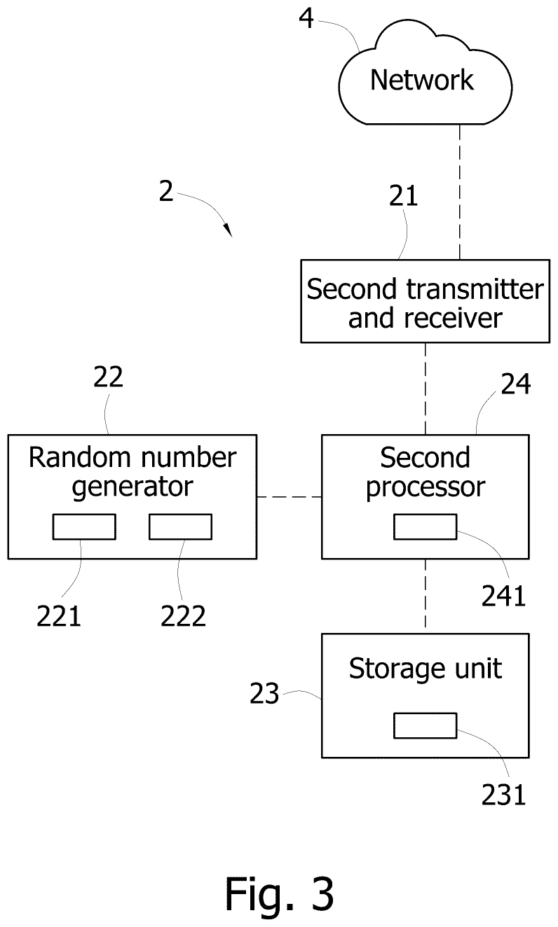

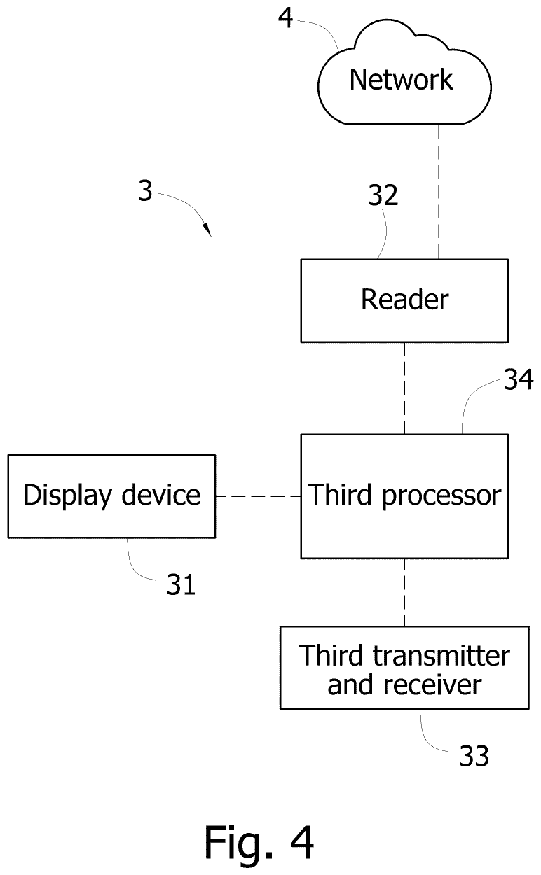

Refer to FIG. 1-4, a real food honesty display system according to the present invention mainly includes at least one on-site recording device 1, a central electronic device 2, at least one remote electronic device 3, and a network 4 used for connecting the central electronic device 2 with both the on-site recording device 1 and the remote electronic device 3 in a wireless manner.

The on-site recording device 1 is disposed in an ecological environment which can be a greenhouse, filed, shed, etc. and used for combining a dynamic video 111 or a sound 121 with a geographic information 131 to form an information set 151. A first transmitter and receiver 14 is used to transmit the information set 151 through the network 4. The central electronic device 2 is connected to the network 4 for receiving the information set 151 from the on-site recording device 1 in the ecological environment by the network 4. Then the central electronic device 2 analyzes the dynamic video 111 or the sound 121 in the information set 151 to get the number of the animal or vibration information including frequency and rhythm of the sound 121 of the animal. A second processor 24 of the central electronic device 2 calculates the number of the animal shown in the information set 151 according to data in a database 231 in a storage unit 23 of the central electronic device 2. Next the e central electronic device 2 outputs a code 241 according to the information set 151. Then the code 241 is printed and attached to food products or food packaging by sales staff in a consumer scene. When consumers use the remote electronic device 3 to read the code 241, the remote electronic device 3 is connected to the storage unit 23 to get the information set 151 and find out where the food is cultivated and information related to planting processes.

The on-site recording device 1 is disposed in at least one ecological environment where food is planted or produced and is activated by a planter such as famer to capture images or sound in the ecological environment for food certification. The on-site recording device 1 consists of an image-sound capture device 11, a positioning device 13, a first transmitter and receiver 14, and a first processor 15. The on-site recording device 1 further includes a sensor 12.

The image-sound capture device 11 is used to capture images of at least one animal and create at least one dynamic video 111 or a sound 121 of the animal. The sensor 12 is for detecting a sound 121 of the animal in the ecological environment. The positioning device 13 can generate a geographic information 131 showing a position coordinate of the image-sound capture device 11 or the sensor 12. The first transmitter and receiver 14 is connected to the network 4 for transmitting a plurality of information sets 151 to the central electronic device 2. The first processor 15 is coupled to the image-sound capture device 11, the sensor 12, the positioning device 13, and the first transmitter and receiver 14. The first processor 15 is provided with at least one application program. The first processor 15 works to activate the image-sound capture device 11, make the positioning device 13 generate the geographic information 131, and combine the dynamic video 111 with the geographic information 131 to form an information set 151. The first processor 15 can also combine the sound 121 with the geographic information 131 to form another information set 151.

The central electronic device 2 receives the plurality of the information sets 151 from the on-site recording device 1 in the ecological environment automatically or in a real time manner through the network 4 to get information related to planting processes and certified by the dynamic videos 111. Then the central electronic device 2 can analyze the respective dynamic videos 111 or the respective sounds 121 in the information sets 151 by a database 231 of the storage unit 23 to calculate the number of the animals or obtain vibration information including audio frequency and rhythm of the animals. The central electronic device 2 includes a second transmitter and receiver 21, a random number generator 22, a storage unit 23, and a second processor 24.

The second transmitter and receiver 21 is used to receive a plurality of the information sets 151 from the on-site recording device 1 and transmit the information set 151 corresponding to the code 241 to the remote electronic device 3 while the remote electronic device 3 is getting access to the code 241. The random number generator 22 generates a set of a first random number 221 and a second random number 222 while the second transmitter and receiver 21 receiving the information set 151. The storage unit 23 is for storage of the set of the first random number 221 and the second random number 222, the information set 151 corresponding to the first random number 221 in the set of the first random number 221 and the second random number 222, and the code 241 corresponding to the second random number 222 in the set of the first random number 221 and the second random number 222. The second processor 24 is coupled to the second transmitter and receiver 21, the random number generator 22, and the data storage unit 23. The information set 151 transmitted after recording of the dynamic video 111 by the on-site recording device 1 is received by the second transmitter and receiver 21 automatically. Then the second processor 24 activates the random number generator 22 to generate the set of the first random number 221 and the second random number 222 which are stored in the storage unit 23. The second processor 24 corresponds the first random number 221 to the information set 151 and saves the information set 151 corresponding to the first random number 221 in the storage unit 23. When the remote electronic device 3 gets access to the code 241, the second processor 24 finds out the second random number 222 corresponding to the code 241, retrieves the set of the first random number 221 and the second random number 222 containing the second random number 222 corresponding to the code 241, and gets the corresponding information set 151 according to the first random number 221 in the set of the first random number 221 and the second random number 222 containing the second random number 222 corresponding to the code 241. Then the information set 151 is output to the remote electronic device 3 by the second processor 24. The information set 151 includes the number, a density, and distribution status of the animals in the ecological environment.

When a food product is delivered from a place where the food is planted or produced to a consumer scene, the sales staff in the consumer scene print or output the code 24 which is then attached to the food product or a food packaging at the consumer scene. Thereby the food product or the food packaging is provided with the code 241. When consumers use the remote electronic device 3 to read the code 241 on the food product or the food packaging, the remote electronic device 3 is directly connected to the central electronic device 2 by the network 4 to find information related to planting processes in the dynamic videos 111 of the information sets 151 and corresponding to the food product in a real-time manner. The remote electronic device 3 is composed of a display device 31, a reader 32, a third transmitter and receiver 33, and a third processor 34.

The reader 32 is used to read the code 241 and the third transmitter and receiver 33 is used for connection with the central electronic device 2 to receive the dynamic videos 111 and the geographic information 131 of the information sets 151. The third processor 34 is coupled to the display device 31, the reader 32, and the third transmitter and receiver 33. After the reader 31 reading the code 241, the third processor 34 gets the information set 151 corresponding to the code 241 and shows the information set 151 on the display device 31.

When users use the remote electronic device 3 to read the code 241, the remote electronic device 3 is directly connected to the central electronic device 2 by the network 4. The second processor 24 finds out the second random number 222 corresponding to the code 241 and then retrieves the set of the first random number 221 and the second random number 222 containing the second random number 222 corresponding to the code 241. Next the corresponding information set 151 is obtained according to the first random number 221 in the set of the first random number 221 and the second random number 222 containing the second random number 222 corresponding to the code 241 and then output to the third processor 34 of the remote electronic device 3 through the second transmitter and receiver 21, the network 4 and the third transmitter and receiver 33 to be displayed on the display device 31 of the remote electronic device 3. Thereby the users (consumers) can review the dynamic video 111 showing planting process of the food they purchase and learn where the food is cultivated according to the geographic information 131 of the information set 151.

The on-site recording device 1 can perform positioning by the geographic information 131 from the positioning device 13, or global positioning information obtained from the global positioning system (GPS).

The on-site recording device 1 can also be connected to the network 4 for live transmission of the ecological environment to show whether at least one planter is cultivating plants in the ecological environment by using natural agriculture or monitor animals in the ecological environment. The on-site recording device 1 which combines the dynamic video 111 or the sound 121 with the geographic information 131 to form the information set 151 can directly get the coordinate from a map database by the network 4 to check the geographic information 131 therein and further obtain positioning coordinate and information of the dynamic video 111 or the sound 121. Then the on-site recording device 1 uploads the information set 151 to the storage unit 23 of the central electronic device 2 by the first transmitter and receiver 14. The information set 15 is stored and recorded as information related to planting process of the on-site recording device 1.

Next the random number generator 22 of the central electronic device 2 generates a set of the first random number 221 and the second random number 222 according to the information set 151. After the random number generator 22 starting operation, the second processor 24 gets and corresponds the first random number 221 included in the set of the first random number 221 and the second random number 222 to the information set 151 which is generated by operation of the on-site recording device 1 by the planter. Then the second processor 24 gets and converts the second random number 222 included in the set of the first random number 221 and the second random number 222 into the code 241 which is output to the sales staff in the consumer scene. Next the code 241 is printed and attached to or output to the food products or food packaging in the consumer scene by the sales staff. Thereby the first random number 221 included in the set of the first random number 221 and the second random number 222 is corresponding to the place where the food is planted or produced while the second random number 222 included in the set of the first random number 221 and the second random number 222 is corresponding to the code 241 on the food products or food packaging in the consumer scene.

When the consumer uses the remote electronic device 3 to read the code 241, the remote electronic device 3 is connected to the storage unit 23 of the central electronic device 2 by the network 4. The second processor 24 finds out the second random number 222 corresponding to the code 241 and then retrieves the set of the first random number 221 and the second random number 222 containing the second random number 222 corresponding to the code 241. Next the information set 151 is obtained correspondingly according to the first random number 221 included in the set of the first random number 221 and the second random number 222 containing the second random number 222 corresponding to the code 241.

The second processor 24 of the central electronic device 2 calculates the number, density, or distribution of the animals shown in the information set 151 according to the dynamic video 111 of the information set 151 combined with data in the database 231. The database 231 can store preset parameters related to animal features (not shown in figure). While processing the information set 151, the central electronic device 2 also retrieves the preset parameters to generate more detailed and accurate animal-related information. The preset parameters come from equations or models built by research or experiments of the animals.

It should be noted that the second processor 24 of the central electronic device 2 can adjust brightness and then perform color space conversion of the dynamic video 111. Next the second processor 24 carries out color identification and classification of the dynamic video 111 by k-means clustering. The images of the dynamic video 111 are further processed by dilation morphology or erosion morphology. Using distribution or density of the animal in the ecological environment over time, images for counting the animals included therein (having images of most of the animals) are generated. Later the second processor 24 performs calculation according to the images for counting obtained to get the number of the animal. Based on the number of the animal, users can learn the ecological environment is getting worse along with the use of pesticides or better without using pesticides. The second processor 24 uses different threshold values to perform the color space conversion of the dynamic video 111 and get adjusted images with different color spaces. Thus animals with different colors can be identified easily by the second processor 24. For example, the second processor 24 performs the color space conversion to the dynamic video 111 using two threshold values including black color and white color so that the images for counting obtained have obvious contrast and the second processor 24 can identify white animals or black animals easily.

Moreover, the second processor 24 is coupled to a vibration circuit which generates sensing information according to electrical signals from the sensor 12 and retrieves phase or amplitude of frequency of the sound 121 of the information set 151 according to the sensing information. The second processor 24 can analyze the frequency of the sound 121 to calculate high frequency sound and low frequency sound of the animal and synthesis the high frequency sound and low frequency sound to generate a vibration information. The vibration circuit consists of an amplifier and an analog-to-digital converter circuit coupled to the amplifier. When the information set 151 is read, the second processor 24 activates the amplifier to amplify the sensing signals of the sound 121 and generate an analog audio signal which is then converted into a digital audio signal by the analog-to-digital converter circuit. Next the vibration circuit calculates frequency features of the digital audio signal by Fast Fourier transform algorithms.

According to the vibration information combined with audio data (such as frequency, rhythm, volume change, intensity change, etc.) built-in the database 231, the second processor 24 calculates and generates an audio information of the animal to learn whether positive emotion or negative emotion of the animal is increased or decreased. Based on the audio information of the animal, users can understand whether the ecological environment becomes worse along with the use of pesticides or better without using pesticides.

The code 241 can be in different forms including barcode, electronic product code (EPC) of Radio-frequency identification (RFID), quick-response (QR) code, etc. When the food product or the food packaging in the consumer scene is provided with the code 241, the reader 32 of the remote electronic device 3 scans the code 241 for authentication and then the central electronic device 2 transmits the information set 151 corresponding to the code 241 to the remote electronic device 3.

After receiving the dynamic videos 111 or the geographic information 131 of the information set 151, all related information in the information set 151 can be shown on the display device 31 of the remote electronic device 3. Thereby users can learn the number, the density, and the distribution status of the animal during the planting process of the food product in the ecological environment and further know whether the ecological environment is getting worse along with the use of pesticides or better without using pesticides.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A real food honesty display system comprising:
at least one on-site recording device, a central electronic device, at least one remote electronic device, and a network used for connecting the central electronic device with both the on-site recording device and the remote electronic device in a wireless manner;
wherein the on-site recording device is disposed in at least one ecological environment and provided with an image-sound capture device used for capturing a dynamic video of at least one animal, a positioning device for generating a geographic information showing a position coordinate of the image-sound capture device, a first transmitter and receiver for transmission of a plurality of information sets;
a first processor coupled to the image-sound capture device, the positioning device, and the first transmitter and receiver;
wherein the first processor is used to activate the image-sound capture device, make the positioning device generate the geographic information, and combine the dynamic video with the geographic information to form the information set;
wherein the central electronic device includes a second transmitter and receiver for receiving the information set from the on-site recording device and transmitting the information set corresponding to a code to the remote electronic device;
a random number generator which generates a set of a first random number and a second random number while the second transmitter and receiver receiving the information set;
a data storage unit for storing the set of the first random number and the second random number, the information set corresponding to the first random number, and the code corresponding to the second random number;
a second processor coupled to the second transmitter and receiver, the random number generator, and the data storage unit;
wherein the second processor corresponds the first random number to the information set and converts the second random number to the code to be output;
wherein when the remote electronic device gets access to the code, the second processor finds out the second random number corresponding to the code, retrieves the set of the first random number and the second random number containing the second random number corresponding to the code, and gets the corresponding information set according to the first random number in the set of the first random number and the second random number containing the second random number corresponding to the code; then the information set is output to the remote electronic device;
wherein the remote electronic device used in combination with the code disposed and displayed on food products or food packaging in a consumer scene includes
a display device,
a reader for reading the code,
a third transmitter and receiver able to be connected with the central electronic device by the network for receiving the information set;
a third processor coupled to the display device, the reader, and the third transmitter and receiver;
wherein after the reader reading the code, the third processor obtains the information set corresponding to the code and displays the information set on the display device.

2. The system as claimed in claim 1, wherein the central electronic device includes a work station, a network server, a laptop computer, and a desktop computer.

3. The system as claimed in claim 1, wherein the remote electronic device 3 includes a mobile phone, a personal digital assistant (PDA), a tablet computer, a personal computer, and a wearable device.

4. The system as claimed in claim 1, wherein the network includes an internet, an Ethernet, a radio frequency (RF) network, a telecommunication network, a wide area network (WAN), a local area network (LAN), a wireless network (Wi-Fi), and a virtual private network (VPN).

5. The system as claimed in claim 1, wherein images of the dynamic video are further processed by the second processor and a plurality of images for counting the animal are obtained by distribution or density of the animal in the ecological environment over time; then the second processor calculates the animal included in the images for counting the animal to get the number of the animal.

6. The system as claimed in claim 1, wherein the on-site recording device further includes at least one sensor which is used for sensing a sound of the animal; the first processor combines the sound with the geographic information to form an information set.

7. The system as claimed in claim 1, wherein the second processor is coupled to a vibration circuit which retrieves frequency of the sound of the information set and generates an audio information of the animal according to the frequency combined with audio data built-in a database of the storage unit.
